(19) United States
(12) Patent Application Publication
(10) Pub. No.: US 2005/0184472 A1
(43) Pub. Date: Aug. 25, 2005

(54) Hydraulically actuated holder

(76) Inventors: Johannes W.G.M. Huijbers, Eden Prairie, MN (US); Dennis L. Mills, Long Lake, MN (US)

Correspondence Address: Malcolm D Reid;Gray Plant Mooty Mooty & Bennett, PO Box 2906, Minneapolis, MN, 55402-0906, US

(21) Appl. No.: 10/502,315

(22) PCT Filed: Feb. 12, 2002
(86) PCT No.: PCT/US02/04714

(30) Foreign Application Priority Data
Feb. 14, 2001 (US) 60268281

(51) Int. Cl. B23B 31/30

(52) U.S. Cl. 279/4.01

(57) ABSTRACT

A hydraulic holder (203) of a cutting tool or workpiece with a hydraulic circuit (211) contained in a cartridge (107) separate from the holder (203). The cartridge (107) is fixedly inserted in an axial bore (106) of the holder for clamping a tool or workpiece. The hydraulic cartridge (107) comprising a first actuator access port (105) in the toolholder; a second actuator access port (108) in a cartridge shell (210); a cartridge body (200) affixed fluid tight in the cartridge shell (210); the cartridge body having (i) a piston cylinder (204) in axial alignment with the first actuator access port and the second actuator access port.

### CROSS REFERENCE TO A RELATED APPLICATION

This application claims the benefit of U.S. Provisional Patent Application Ser. No. 60/268,281 filed Feb. 14, 2001.

### BACKGROUND OF THE INVENTION

1. Field of the Invention

The invention described in this specification relates generally to an improved hydraulically actuated holder of a tool or workpiece for rotating machining devices including, but not limited to, milling machines. More particularly it relates to an improved hydraulically actuated holder with a hydraulic cartridge inserted into the holder or affixed exteriorly to the holder for clamping a workpiece onto the cartridge.

2. Description of Prior Art

Holders, and more specifically toolholders, are used primarily to provide the flexibility of using a variety of cutting tools in milling machines. Milling machine toolholders are currently on the market that are, for example, suited to hold end mills, drills, boring bars, taps and reamers. Typically one side of a toolholder for a milling machine has a tapered shank according to one of the accepted taper standards for milling machines, such as a BT-taper, a CAT-taper, or an HSK-taper. The tapered shank fits tightly into the tapered recess in the rotating spindle of the milling machine. The other side of the toolholder, the nosepiece, has a clamping mechanism for holding a cutting tool. There are a variety of toolholder clamping mechanism designs on the market.

One of the most widespread toolholder designs is the set-screw type, where the cutting tool shank is held in the toolholder bore by one or more set-screws. Another is the collet-type, where the cutting tool shank is held by a collapsible or tapered collet, which is pressed onto the cutting tool shank. These designs are relatively inexpensive. They do not, however, offer very high total indicated run-out accuracy, which is the maximum possible distance the cutting tool center location is off the shank centerline of the toolholder. A hydraulically actuated toolholder, although more expensive than the set-screw or the collet-type toolholder, has a much higher total indicated run-out accuracy. It is for this reason that a hydraulically actuated toolholder is used in more demanding, high-speed cutting operations.

A hydraulically actuated toolholder holds the shank of a cutting tool by hydraulically compressing a thin shell or wall around the cutting tool shank. The toolholder has an internal hydraulic circuit that is a reservoir for containment of hydraulic fluid around the thin shell wall. The inside of the shell forms the bore of the toolholder. The hydraulically actuated toolholder also has a means for compressing hydraulic fluid within the hydraulic circuit. It also has the necessary hydraulic passages to connect the hydraulic circuit surrounding the thin shell wall to the means for compressing the hydraulic circuit and for connecting multiple clamping bands of the hydraulic circuit. The necessary hydraulic pressure to compress the thin shell wall and provide enough holding torque for the cutting tool (usually about 15,000 psi) is generated by displacing the hydraulic fluid within the hydraulic circuit. Hydraulically actuated toolholders currently on the market all have an integral hydraulic circuit. One particular type of design has the main part of the hydraulic circuit machined in a bore of the toolholder and a thin shell, which completes the hydraulic circuit, inserted and brazed into the bore. Another type has the main part of the hydraulic circuit machined into the exterior of the toolholder nosepiece with a non-deformable shell welded around the nosepiece to complete the hydraulic circuit. With this type of integral hydraulic actuator, one or more annular segments of the bore of the toolholder forms the deformable or compressible thin shell for retaining the cutting tool. Both designs have hydraulic circuits with relatively intricate geometry. As a result of their integral design approach, they are expensive and difficult to manufacture.

A further disadvantage of the intricate geometry of the hydraulic circuit is that it is difficult to remove debris accumulated during manufacture of the integral hydraulic cartridge. The resultant contamination of the hydraulic circuit can cause excessive wear of the piston seal, resulting in reduced seal life and possible leakage. And, this in turn can cause the toolholder to generate insufficient holding torque. Furthermore, the intricate geometry makes it difficult to fill the hydraulic circuit completely and consistently with hydraulic fluid, causing a relatively high percentage of air to be entrapped in the hydraulic fluid. This causes lower hydraulic pressure within the hydraulic circuit and resultant lower holding torque between the toolholder and the cutting tool. Also the volume of the hydraulic circuit for the integral design is quite large, demanding a relatively high piston compression stroke to adequately compress the hydraulic fluid within the hydraulic circuit, which is disadvantageous.

The invention described in this specification provides a solution to the problems resulting from the integral design of the hydraulic circuit of the currently available hydraulically actuated toolholders. Another aspect of the described invention is a holder designed to function as a mandrel for holding a workpiece rather than a cutting tool. Because of the dual nature of this invention's use as a toolholder or a workpiece-holder, this invention is more accurately referred to as a “holder.”

### SUMMARY OF THE INVENTION

In contrast to the prior art hydraulically actuated toolholders, this invention substitutes a separate hydraulic cartridge inserted into the bore of a holder in place of the integrally machined hydraulic circuit of presently known hydraulically actuated toolholders. This invention separates the design functions of locating and retaining the holder in the recess of the milling machine's rotating spindle from that of locating and retaining the cutting tool or workpiece in the clamping mechanism in the nosepiece of the holder.

The hydraulic holder of this invention consists of two main parts, the holder and the hydraulic cartridge. The holder performs the first design function. It has a shank on one end that fits into a recess of a rotating spindle of a machining device. A holder of this invention may have a tapered shank for mating with the tapered recess of a milling machine or it may be configured for mating with other machining devices requiring a cylindrical shank, for example. The other end of the holder has a bore on the centerline of the tapered shank. The second main part of the hydraulic holder, the hydraulic cartridge, is during assembly, for example, pressed by an arbor press into the bore of the holder in an interference fit to locate it accurately and to retain it tightly in place. The separation of the two design functions allows for relatively inexpensive and simple manufacturing of the two parts, the holder and the cartridge, of the hydraulic holder of this invention.

The hydraulic cartridge completely contains the hydraulic retention or clamping mechanism, which includes the hydraulic circuit of the hydraulic holder. The cartridge comprises a thin walled cylindrical body surrounding an axially aligned inner bore and a cylindrical outer shell. The entire hydraulic circuit is machined into the exterior circumferential wall of the body. The cartridge body is pressed into the outer shell and the two are subsequently brazed to provide a leak-tight hydraulic circuit.

The cartridge concept allows for a very simple hydraulic circuit design with a volume roughly one third that of the hydraulic toolholder designs currently on the market with an integral hydraulic circuit concept. Furthermore, the cartridge body and shell are very easily deburred and cleaned before they are assembled and brazed together, making the possibility of contamination in the hydraulic circuit very small. In one embodiment of this invention, the hydraulic circuit, which surrounds the thin inner wall of the cartridge body, is divided into two thin-shelled bands with a thicker band shell separating the two thin bands. The thin-shelled bands are deformable towards the axis of cartridge inner bore during hydraulic actuation of the cartridge. Having two deformations bands results in well-defined clamping and alignment of the cutting tool shank in two shank locations within the inner bore of the cartridge body. Having only one deformation band could result in nonuniform clamping and alignment, depending upon the particular design geometry and fluid volume of the cartridge. However, for certain applications one deformation band may provide adequate clamping.

The hydraulic circuit is divided into three distinct fluid volumes with channels interconnecting the fluid volumes. The first two fluid volumes are the upper clamping volume and the lower clamping volume. The upper clamping volume is contained by the upper clamping band, which is formed by the first annular positioning ring, the second annular positioning ring, and the deformable thin shell like wall of the body between the first and second annular positioning rings, and the outer cartridge shell. The lower clamping volume is contained by the lower clamping band, which is formed by the second annular positioning ring, the third annular positioning ring, the deformable thin shell like wall of the body between the second and the third annular positioning rings, and the outer cartridge shell. The lower clamping fluid volume, which is contained around the lower clamping band, is connected to the upper clamping fluid volume, which is contained around the upper clamping band, by one or more channels that may be u-shaped grooves. In a first embodiment of the invention there are two channels. The channels are cut longitudinally through the second annular positioning ring of the cartridge body. Each channel may be positioned up to 180 degrees clockwise or counter-clockwise from the other in the two-channel embodiment. During filling of the hydraulic circuit of the two-channel embodiment, the fluid generally flows through one channel to fill the lower clamping band with hydraulic fluid while most of the displaced air from the lower clamping band evacuates or bleeds through the other channel. The upper clamping band is connected with a piston bore by a single channel groove in the first annular positioning ring of the cartridge body, or alternatively two parallel channel grooves. This fill and or bleed channel may be inline with one of the clamping channels in the second annular positioning ring of the body. The fill/bleed channel allows for both filling with hydraulic fluid and evacuation of air from the lower and upper clamping bands. The fill channel is easily accessible through a piston bore for inserting thin tubing during the filling procedure. The piston bore may run radially all the way through the cartridge body and, if it does run entirely through the body, it is sealed on one side by the cartridge outer shell. The other side of the cartridge outer shell has a through-hole to allow for installation of a piston seal, piston, and actuator. The design of the hydraulic circuit of this invention eliminates the need for a bleed hole separate from the fill hole as required by the currently available hydraulically actuated toolholders. Furthermore, the design of this invention results in virtually no entrapped air after hydraulic fluid filling, thereby eliminating another disadvantage of current hydraulic toolholder designs, which did not consistently eliminate all of the air.

The piston seal has a through-hole on its centerline, which obviates the need for a bleed hole separate from the fill. The through-hole allows for the escape of excess oil out the through-hole into the first and second actuator access port end of the piston bore for removal. The piston has a pin, which fits tightly into the through-hole of the piston seal after the piston seal is seated at the designed for location. During actuation by the combination of an actuator and the piston, the fully installed piston seal is forced to travel deeper into the piston bore, increasing the pressure on the volume of hydraulic fluid in the hydraulic circuit and thereby raising the pressure in the upper and lower clamping bands. The increase in pressure in the upper and lower clamping bands causes the thin shelled deformable bands to deform towards the axis of the cartridge of the bore to engage the shank of a cutting tool or workpiece that may be in the cartridge inner bore.

A slightly different application of the hydraulic cartridge is its use as an expanding mandrel, that is its direct use as a workpiece holder or lathe chuck. The inner bore of the cartridge fits around a cylindrical end of a holder or chuck. In this application, a flexible deformable outer cartridge shell will fit inside a workpiece. The actuation of the holder or chuck will expand the outer shell against the inner wall of the workpiece bore, thus holding the workpiece in place. It is of course possible just to integrate the cartridge into the holder or chuck, as the geometry for an expanding mandrel type holder is very suitable for such a design. The filling and installing of the piston seal and piston can be done in an identical way to that done when using the cartridge as previously described in this specification. The location of the piston bore may be changed to improve accessibility. For example, the piston bore may extend into the cartridge in a direction in line with or parallel to the axis of the cartridge to connect with the fill/bleed channels.

Accordingly, certain of the objects of this invention are to provide a hydraulically actuated holder that (i) eliminates contamination in the hydraulic circuit and thereby reduces seal wear and hydraulic holder failure, (ii) is less expensive and simpler to manufacture, (iii) eliminates the need of a bleed hole separate from the fill/bleed channel, (iv) reduces the overall volume of the hydraulic circuit, (v) virtually eliminates the presence of air in the hydraulic circuit, and (vi) wherein the hydraulic actuation means is in a cartridge insert separate from the portion of the holder that mates with a milling machine. These and other objects of the invention described and claimed in this specification will become apparent with reference to drawings, the description of embodiments of the invention, and the claims.

### DESCRIPTION OF THE DRAWINGS

FIG. 1 is an isometric view of cartridge holder of this invention, comprising holder body and cartridge.

FIG. 2 is a cross-sectional view of the assembled cartridge holder with the holder body, cartridge, piston seal, piston, and actuator.

FIG. 3A is an isometric view of the cartridge shell.

FIG. 3B is an isometric view of the cartridge body.

FIG. 3C is an isometric view of the hydraulic circuit within the cartridge, showing the clamping fluid volumes, the fluid flow channels between the clamping fluid volumes, the piston cylinder fluid volume, the fill channel fluid volume, and the bleed channel fluid volume.

FIG. 4A is an isometric view of the cartridge shell for the second embodiment of the cartridge body illustrated in FIG. 4B.

FIG. 4B is an isometric view of a second embodiment of the cartridge body having a co-located single channel for both filling the cartridge with hydraulic fluid and for bleeding air from the clamping bands.

FIG. 4C is an isometric view of the hydraulic circuit of the second embodiment of FIG. 4B.

FIG. 5 is a cross-sectional view of the cartridge with the piston seal installed.

FIG. 6 is a cross-sectional view of the cartridge with the piston seal and the piston installed.

FIG. 7 is an isometric view of a mandrel-type holder with a separate cartridge containing the complete hydraulic circuit.

FIG. 8 is an isometric view of a mandrel-type holder with an integrated hydraulic circuit.

FIG. 9A is a plan view of the seal.

FIG. 9B is an elevation view of the seal.

FIG. 10A is a plan view of the piston.

FIG. 10B is an elevation view of the piston.

FIG. 11 is an elevation view of the actuator.

FIG. 12A is a plan view of the cartridge body.

FIG. 12B is an elevation view of the cartridge body.

FIG. 12C is a section of the cartridge body along line A-A as that line is shown in FIG. 12B.

FIG. 12D is a section of the cartridge body along line B-B as that line is shown in FIG. 12B.

FIG. 13A is an elevation view of a tool for insertion of a seal into the cartridge piston bore of the invention.

FIG. 13B is an end view of the insertion tool of FIG. 13A.

FIG. 14 is an isometric view of a prior art toolholder.

### DETAILED DESCRIPTION OF THE INVENTION

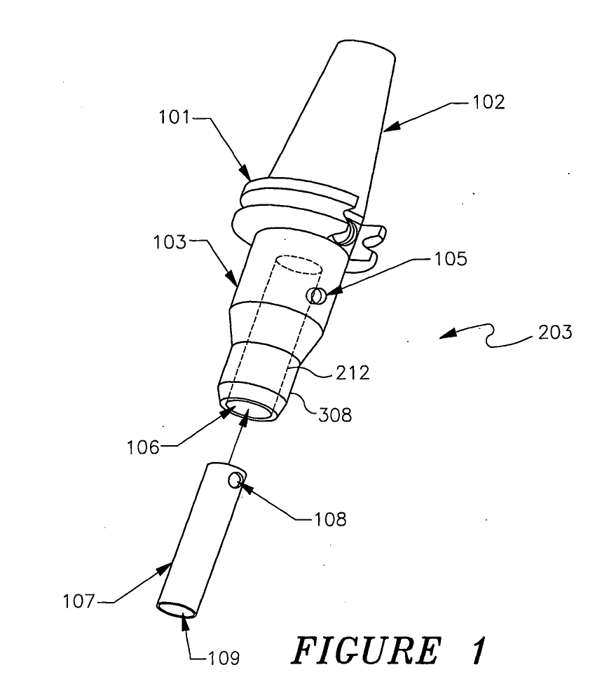

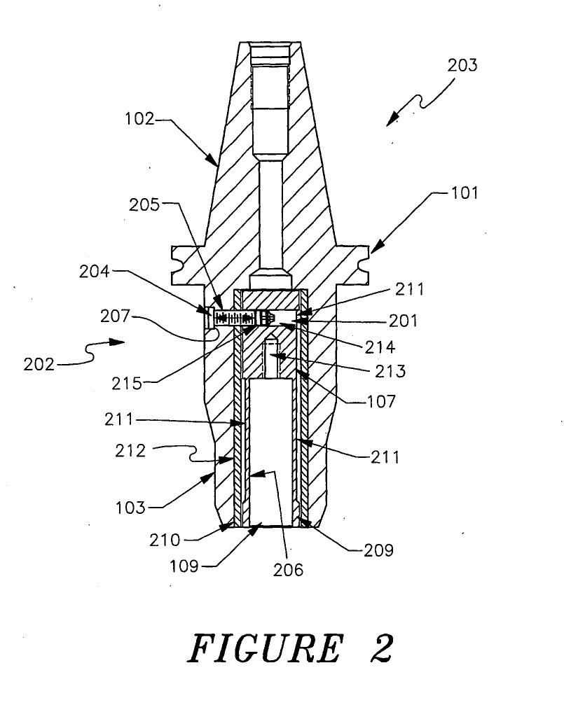

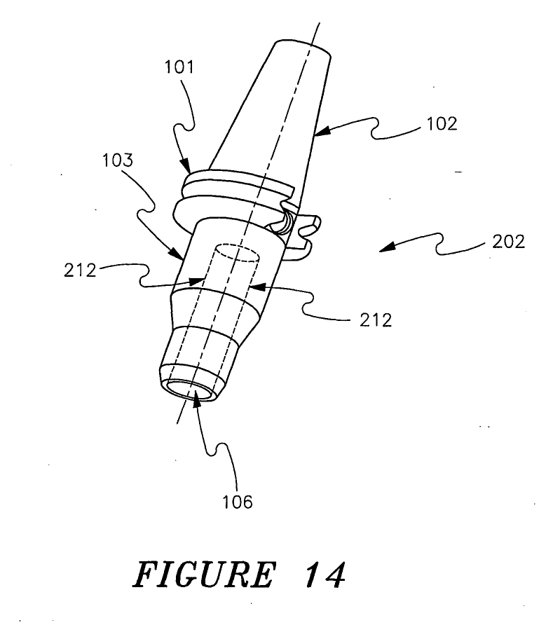

FIG. 1 is an isometric view of an embodiment of the hydraulically actuated cartridge holder 203 of the invention described in this specification. The cartridge holder 203 is comprised of a modified prior art toolholder 202 as shown in FIG. 14 and cartridge 107 as shown in FIG. 1. Prior art toolholder 202 is commonly used in the computer numeric controlled (“CNC”) machining industry. One side of the commonly used toolholder of FIG. 14 has a tapered shank 102 according to one of the accepted taper standards for milling machines, such as a BT-taper, a CAT-taper, or an HSK-taper. The tapered shank 102 fits tightly into the tapered recess in the rotating spindle of the miling machine. However, the shank may be of any configuration such as a cylinder as required to matingly fit into the chosen machining device. The other side of the toolholder, the nosepiece 103, has a clamping mechanism (shown in FIG. 14 as a bore 106 defined by the wall 212 for forming, for example, an interference fit with a cutting tool) for holding a cutting tool. The nosepiece 103 is shown having a first diameter and a second diameter for illustration purposes only, but in practice the nosepiece 103 may be a single diameter cylinder, a taper, or some other shape as may be determined to be most advantages for a given application. In fact, nosepiece 103 may merely be an extension of shank 102 and if shank 102 is, for example, a taper then the nosepiece 103 could be a continuation of the taper. Additionally, nosepiece 103 may be eliminated and the clamping mechanism may be within shank 102 and thereby extend into the recess of the machining device. V-flange collar 101 between shank 102 and nosepiece 103 engages with CNC equipment for automated insertion and removal of the toolholder from the spindle of the CNC machine. If the toolholder is not to be used with CNC equipment, the V-flange need not be present. FIG. 1 illustrates cartridge 107 of this invention in axial alignment with the axis of holder 203 in position for insertion into bore 106. Insertion may be accomplished by several methods such as cooling cartridge 107 prior to insertion and/or heating holder 203 in the region of bore 106 for relatively smooth low force cartridge 107 insertion. Upon stabilization of the temperatures of holder 203 and cartridge 107 to ambient temperature, bore 106 engages cartridge 107 in what may be an interference fit designed to provide locational accuracy required within the working range of cartridge holder 203, as shown in FIGS. 1 and 2. The relative overlap of the outside diameter of cartridge 107 and the inside diameter of bore 106 is a design choice that is somewhat dependent upon the accuracy of the cutting tool to be inserted into the inner bore 109 of cartridge 107 and other typical factors considered in machine tool design. To provision holder 203 with insertable hydraulically actuated cartridge 107 of this invention, the inside diameter of bore 106 must be sized to accommodate the outside diameter of cartridge 107, depending upon the retention method used such as an interference or locational fit as mentioned above in this Detailed Description of the Invention. Holder 203 also requires that first actuator access port 105 be drilled or otherwise formed radially along a diameter of holder 203 so that it is axially aligned with cartridge piston bore 108 when cartridge 107 is inserted into bore 106. First actuator access port 105 will accommodate actuator 204, which is used to increase or decrease compressionment of the hydraulic fluid within hydraulic circuit 211 of cartridge 107 for gripping or releasing, respectively, the cutting tool held in inner bore 109. Actuator 204 may be a cap screw or some other drive member that is forward and backward adjustable along the axis of piston cylinder 201. Alternatively, the actuator and the piston may be combined to form one integral piece. The operation, construction, and inventive concepts of cartridge holder 203 are best described by collective reference to FIGS. 1, 2, 3A, 3B, 3C, 5, and 6.

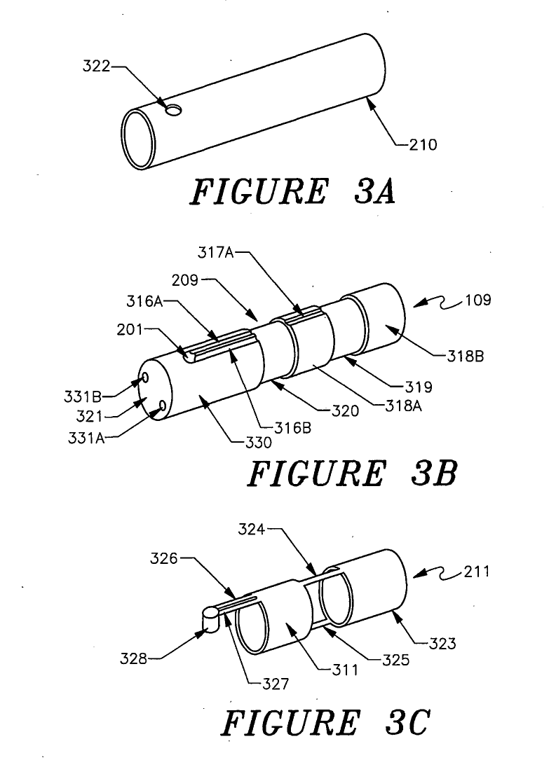

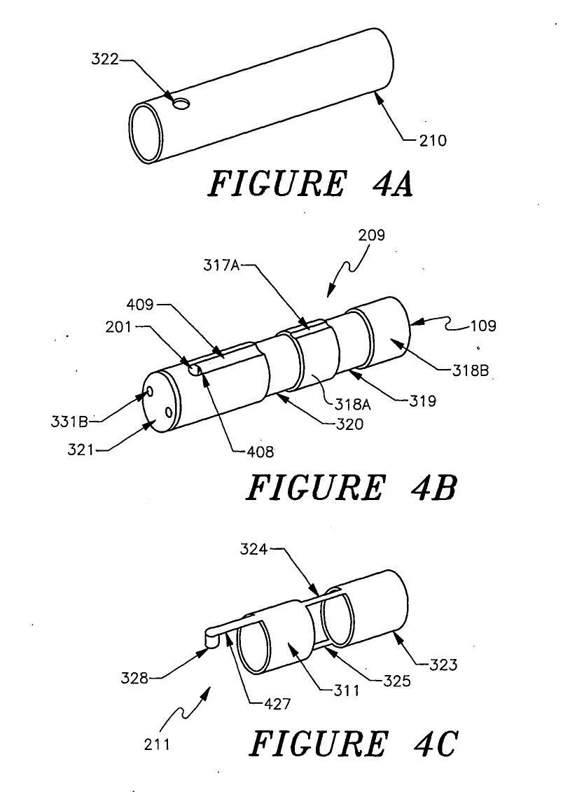

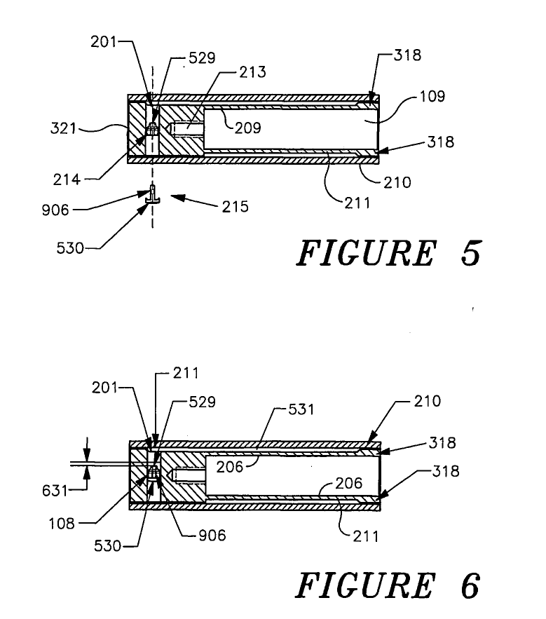

FIG. 2 is a cross-sectional view of assembled cartridge holder 203 comprising a means for mating with a milling machine, for example, and a means for holding hydraulic cartridge 107. Prior art toolholder 202 as shown in FIG. 14 is an example of what may serve as a means to accomplish both functions. FIG. 2 further illustrates cartridge 107, seal 214, piston 215, and actuator 204 as parts of the assembled cartridge holder 203. FIGS. 3A, B, and C are, respectively, isometric views of cartridge shell 210; cartridge body 209; and hydraulic circuit 211, which collectively comprise cartridge 107. Hydraulic cartridge 107 completely contains the hydraulic clamping mechanism that is integrally machined into prior art hydraulic toolholders. The clamping mechanism is the means for securing a cutting tool or a workpiece in the cartridge holder 203 of this invention. When used to secure a workpiece, the holder of this invention is, functioning in effect, as a mandrel. The hydraulic clamping mechanism is a closed loop space that contains hydraulic fluid. Hydraulic fluid as used in this specification is any liquid. However, for most applications of this invention, the hydraulic fluid used in the clamping mechanism will be a fluid of low viscosity such as oil typically used in most hydraulically operated mechanisms. The hydraulic clamping mechanism is referred to as the hydraulic circuit 211 in this specification. The hydraulic circuit 211 is a reservoir for containment of the hydraulic fluid used in this invention to transmit pressure to, for example, a deformable inner wall 206 (FIG. 6) for clamping some object such as a tool or a workpiece in the inner bore 109 of the cartridge 107. In this specification the terms tool or workpiece may be used interchangeable and when either term or both terms are used they are intended to mean either a tool, a workpiece, or both, as the context may dictate. FIG. 3C illustrates hydraulic circuit 211. FIG. 3C is actually a diagram of the space that makes up hydraulic circuit 211 and is not an illustration of the physical enclosure that defines hydraulic circuit 211 space. The physical enclosure is the combination of cartridge shell 210 and cartridge body 209. Another way of describing FIG. 3C is that it is a depiction of the hydraulic fluid in hydraulic cartridge 107. Fully assembled cartridge 107 as shown in FIGS. 5 and 6 is the physical enclosure that defines the hydraulic circuit 211 space. However, FIG. 3C is the clearest representation of that space. Hydraulic circuit 211 of FIG. 3C is comprised of upper and lower clamping fluid volumes 311 and 323, fluid flow channels 324 and 325 between upper clamping fluid volume 311 and lower clamping fluid volume 323, piston cylinder fluid volume 328, fill channel fluid volume 326, and bleed channel fluid volume 327. Upper and lower clamping volumes 311 and 323 are also comprised of deformable portions of inner wall 206 that deform inward into inner bore 109 to clamp a tool or workpiece in inner bore 109. Hydraulic circuit 211 is further defined by cartridge shell 210, which tightly surrounds cartridge body 209 in which hydraulic circuit 211 is machined. FIGS. 5 and 6 illustrate in more detail the construction of cartridge 107, including the assembly of piston 215 with its piston cap 530 and seal 214 into piston cylinder 201. FIGS. 4A, B, and C illustrate an alternative embodiment of cartridge 107. The only difference between this embodiment and the embodiment illustrated in FIGS. 3A, B, and C is that in FIG. 4B, there is illustrated a collocated fill and bleed channel 409 and in FIG. 4C the hydraulic circuit 211 also depicts a collocated fill and bleed channel fluid volume 427, whereas in the embodiment of FIGS. 3B and C there are separate bleed and fill channels 316A and B and separate bleed and fill fluid channel volumes 326 and 327. The cartridge shells 210 shown in FIGS. 3A and 4A are identical.

Hydraulic circuit 211 is filled with fluid through piston cylinder 201. Filling is normally accomplished by the manufacturer of the cartridge holder 203 and is not a user task. Piston cylinder 201 also allows air to bleed out of the spaces that make up hydraulic circuit 211 during the filling process. When the filling process is complete, the combination of actuator 204, piston 215, and seal 214 act to close off piston cylinder 201 so that hydraulic circuit 211 becomes a closed loop system. Moving actuator 204 so that it travels deeper into piston cylinder 201 compresses the hydraulic fluid in hydraulic fluid circuit 211. As a consequence of the compression, portions of inner wall 206 of cartridge 107 within inner bore 109 of the cartridge body 209 bear inwardly towards the longitudinal axis of cartridge holder 203 to clamp or tightly grip a cutting tool or workpiece in inner bore 109 in the regions of circumferential upper and lower clamping bands 320 and 319. The amount of compression depends upon the inward seal displacement 631 of seal 214 by actuator 204 and piston 215. The cutting tool or workpiece is removed from inner bore 109 by backing-out actuator 204 from piston cylinder 201, which reduces compression of hydraulic fluid and in turn relieves the clamping force of cartridge inner wall 206 on a cutting tool in the bore. Inner wall 206 thickness in the regions of the clamping bands 319 and 320 is a function of designed-in displacement 631, volume of hydraulic circuit 211, diameter of the cutting tool for which cartridge holder 203 is designed, material type, and other commonly considered factors in machine holder design.

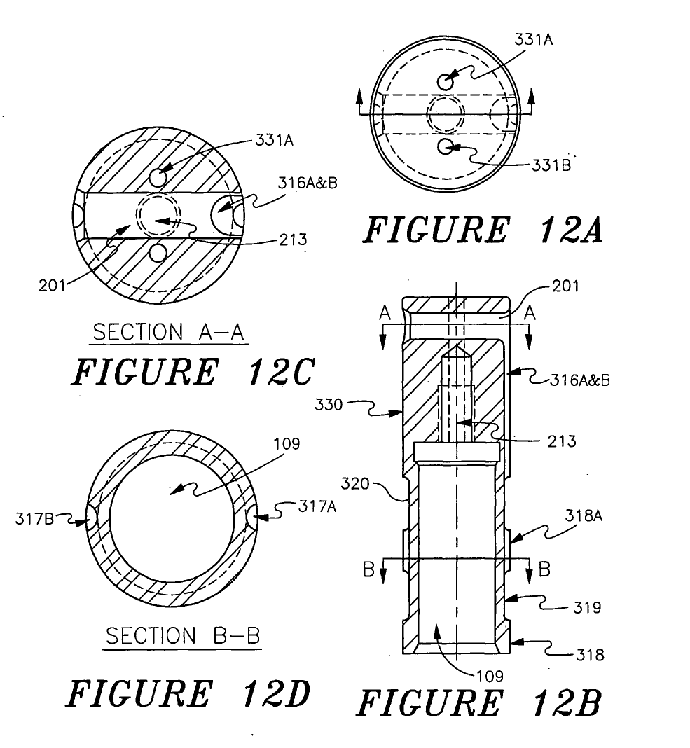

FIG. 3A illustrates cartridge shell 210. The outside diameter of cartridge shell 210 is substantially equivalent to the inside diameter of bore 106. Third annular positioning ring 318B, second annular positioning ring 318A, and first annular positioning ring 330 each have an outside diameter substantially equivalent to that of the inside diameter of cartridge shell 210. These diameters must be substantially equivalent to each other to the degree that when body 209 is press fitted into shell 210 there is essentially no leakage of hydraulic fluid between the interfaces of three positioning rings, 318A and B and 330, and the inside diameter of shell 210. Body 209 is preferably milled from solid stock to form integral positioning rings, 318A, 318B, and 330 each of which has the same diameter. Upper and lower clamping bands 319 and 320 are machined to have a smaller diameter than the positioning rings. Generally, upper and lower clamping bands 319 and 320 will be of the same diameter as one another, but design constraints or benefits may dictate otherwise. First and second clamping channels 317A and B may be longitudinally cut through second annular positioning ring 318A to a depth of design choice, usually in the shape of a u-shaped groove. Fill and bleed channels 316A and B may be longitudinally cut in a similar manner. These channels may have a rounded surface where they meet piston cylinder 201. Coolant ports 331A and B are drilled through cartridge end 321 of cartridge body 209 into bottom of cartridge inner bore 109 if coolant is to be used. Especially with the use of coolant, the cutting tool shank end needs to be backed-off from the bottom of inner bore 109 to allow circulation of coolant fluid from inlet coolant ports 331A or 331B into cutting tool bore and out through the cutting tool. FIGS. 12A through 12C illustrate the placement of pre-set adjustment screw threads 213 for insertion of a back-off member (not shown in drawings) to the required depth in the bottom of inner bore 109 for the purpose of holding the end of the tool or workpiece away from the end of cartridge inner bore 109. The cavity formed by the space between the end of the cartridge inner bore 109 and the end of the tool or workpiece can serve as a coolant cavity and/or be used to longitudinally position a tool or workpiece in the cartridge inner bore 109. The back-off bore may be threaded to accommodate an adjustable back-off member such as a threaded screw. The back-off member can also be a stud or an adjustable member other than a screw. The relative placement of coolant ports with respect to threaded back-off bore 213 are also shown in FIGS. 12A and B. It is a design choice whether to use two or more coolant inlet ports 331 or a single port 331, which is determined at least in part by the heat generated by the cutting tool while under load. Inner bore 109 is machined out of body 209 to the required depth, depending upon the cutting tool or workpiece for which cartridge holder 203 is designed to accommodate. FIG. 12B more clearly illustrates the rounded edge at the junction of the fill and bleed channels 316A and B and piston cylinder 201. The rounded edge allows easy insertion of a fill tube into the fill channel 316A for filling the hydraulic circuit 211 with hydraulic fluid. There is a small taper at the lead-in to piston cylinder 201. FIG. 12D (a transverse cut through second annular positioning ring 318A) illustrates both the first and second clamping flow channels 317A and B.

After cartridge body 209 is press fitted into cartridge shell 210, both are then brazed or flow soldered together around their circumferences at the inner bore end 109 and the cartridge insertion end 321 to provide a leak-tight hydraulic circuit 211. Cartridge body 209 and shell 210 are press fitted together so that second actuator access port 322 and piston cylinder 201 of cartridge body 209 are in axial and radial alignment. Furthermore, assembled cartridge 107 is press fitted into holder 202 so that second actuator access port 322 is in axial and radial alignment with first actuator access port 105.

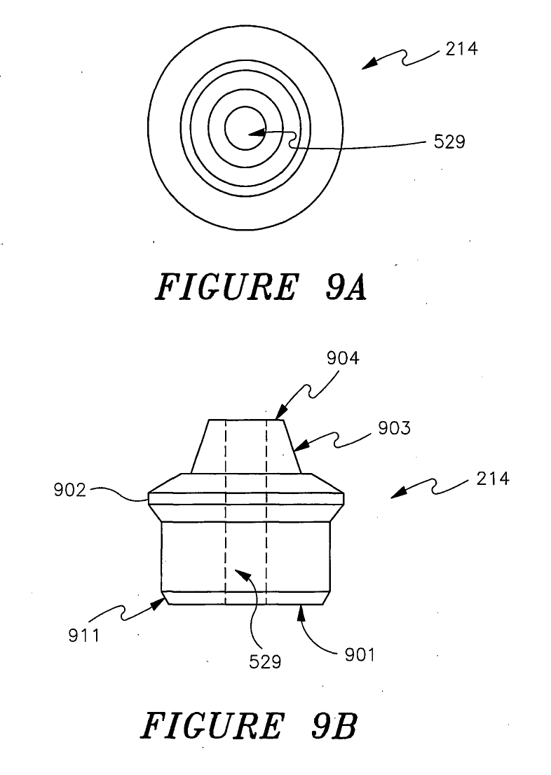

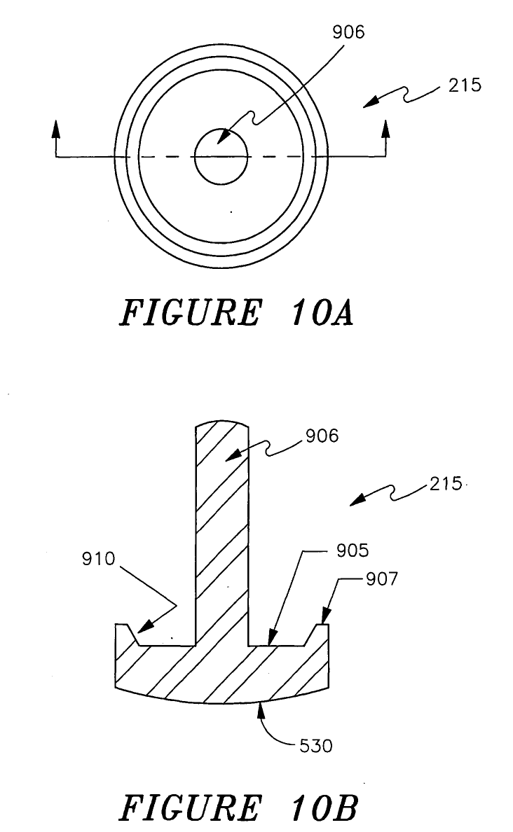

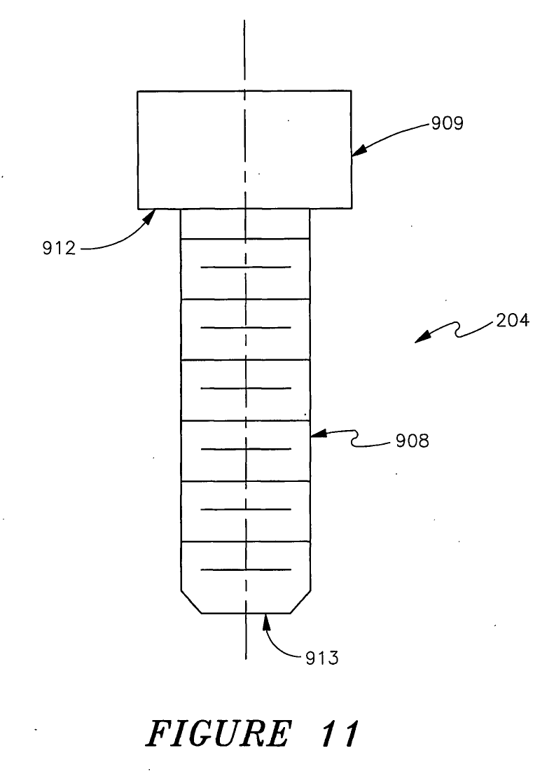

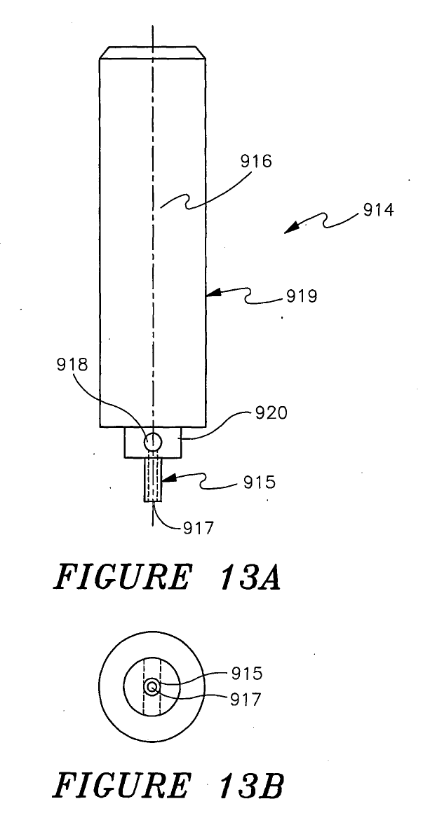

FIG. 3B illustrates two parallel channels 316A and B. These channels are for filling hydraulic circuit 211 with hydraulic fluid during manufacture of cartridge 107. Piston cylinder 201 acts as both a fill port and as the guideway for piston 215, seal 214, and actuator 204. The assembled cartridge 107 is usually filled by inserting a fill tube into piston cylinder 201. The fill tube is directed to fill channel 316A or B, so that a major portion, if not all, of the hydraulic fluid travels along channel chosen for filling and not the other channel which serves as a bleed channel. It has been found that tilting cartridge 107 at an angle from vertical during filling reduces fill time and facilitates removal of air from hydraulic circuit 211. Also, during the filling process, channels 316A and 316B are maintained in the up position since the only access point for filling is piston cylinder 201, which connects with channels 316A and B. Piston cylinder 201 is a bore along the entire diameter of cartridge body 209 in the region of the first annular positioning ring 330. The termination of piston cylinder 201 on the outside circumferential wall of first annular positioning ring 330 opposite second actuator access port 322 (FIG. 3A) connects with fill channel 316A (or 316B) and with bleed channel 316B (or 316A). Hydraulic fluid flows into fill channel 316A, then into upper clamping band 320, initially through first clamping flow channel 317A, and next into lower clamping band 319. As fluid continues to flow into hydraulic circuit 211, air bleeds out of bleed channel 316A or B and then out of piston cylinder 201. As lower clamping band 319 fills, air is evacuated through second clamping flow channel 317B (as shown in FIG. 12D). Finally, as upper clamping channel 320 fills, air continues to bleed out of bleed channel 316B, which in turn fills with hydraulic fluid as does a portion of piston cylinder 201. As piston cylinder 201 fills, the hydraulic fluid feed is shut off and seal 214 is inserted into cylinder 201. Seal 214 is shown in detail in FIGS. 9A and B. As seal 214 is inserted into cylinder 201, excess fluid flows out of oil/air escape through-hole 529. Seal 214 is seated to a predetermined depth in piston cylinder 201 and then piston 215 is inserted into piston cylinder 201 as shown in FIG. 13B so that piston pin 906 inserts into oil/air escape through-hole 529. FIGS. 10A and B show piston 215 in detail. As depicted in FIG. 9B, seal 214 has seat 904 for direct contact with hydraulic fluid. The diameter of seat 904 may be less than that of piston cylinder 201 for ease of starting insertion into piston cylinder 201. Taper 903 provides gradual enlargement approaching the diameter of piston cylinder 201. Flange 902 provides an area of positive engagement between seal 214 and piston cylinder 201. In fact, the diameter of flange 902 somewhat exceeds cylinder diameter so that flange 902 is compressed by cylinder 201, thereby providing a leak-proof seal between piston seal 214 and piston cylinder 201. Seal 214 is fabricated of a material that will allow for periodic longitudinal movement within piston cylinder 201 without breaking seal 214 or tearing or otherwise unduly wearing seal 214. As piston pin 906 travels further into oil escape through-hole 529, seal engagement surface 905 of piston cap 530 engages seal 214 at its piston engagement end 901. Seal compressor 907 has compression taper 910 that matingly engages with engagement end taper 911, whereby the larger engagement end taper 911 of seal 214 is compressed by the smaller compression taper 910 of piston 215 for positive engagement and seating of the piston 215 against seal 214. Finally, actuator 204, as shown in detail in FIG. 11, is threaded into holder body 202. If actuator 204 is a threaded screw, it can be adjusted in and out of piston cylinder 201 using a screwdriver, for example, inserted into head cap 909. Shoulder 912 of head cap 909 acts as a stop when it meets neck 207 (shown in FIG. 2), its mating stop in holder body 202, to limit the depth actuator 204 can be inserted into piston cylinder 201. Actuator 204 is threaded into cylinder 201 so that it engages piston cap 530. Piston cap 530 is beveled to present a relatively small surface area to contact end 913 of actuator 204. The purpose for which is to disengage the turning force of actuator 204 from piston 215 and ultimately seal 214. Too much turning of piston 215 will result in premature wear of seal 214.

Hydraulically actuated toolholders with an integral hydraulic circuit are slow and difficult to completely fill with hydraulic fluid, causing a relatively high percentage of air to be entrapped in the hydraulic fluid. The design of the present cartridge as illustrated in FIGS. 3A, B, and C eliminates this problem by eliminating the need for a bleed port separate from the fill port (the port for fill/bleed channels 316A and B is collocated in piston cylinder 201, which connects with channels 316A and B). After filling the hydraulic cartridge 107, piston cylinder 201 then serves to house actuator 204, piston 215, and seal 214 in axial and radial alignment with piston cylinder 201 and first actuator access port 105. Toolholders with an integral hydraulic circuit are usually filled with hydraulic fluid in a vacuum. The oil enters through a fill hole port at the bottom of the hydraulic chamber and the air rises to and escapes through a bleed hole port at the top of the chamber. The vacuum exhausts much of the air through the bleed hole port at the top of the integral chamber. Besides leaving some quantity of air in the chamber, it is difficult to insert a leak proof seal in the fill port at the bottom of the integral hydraulic chamber using the two port vacuum method of filling an integral hydraulic circuit. The present invention eliminates these problems by using either channels 316A or B as a channel to fill the hydraulic circuit 211 and the other channel to bleed the hydraulic circuit 211 or by using a collocated bleed and fill channel 409 as shown in FIG. 4A. Hydraulic fluid enters from fill channel 316A or B into upper clamping band 320, then through first and second clamping channels 317A and B, and then into lower clamping band 319. As soon as hydraulic fluid enters into lower clamping band 319, air begins to exhaust through one or both first or second clamping channels 317A and B and likewise begins to exhaust through the fill/bleed channel 316A or B that is not being used as the fill channel. Regardless of which channel is used as the fill channel, the other will become the bleed channel. It is important that virtually all trapped air be removed from the closed hydraulic circuit. Compressible air remaining in the hydraulic circuit 211 will lower the maximum gripping force of a hydraulically actuated holder whether the hydraulic circuit 211 is integral to the holder or is manufactured with a separate hydraulic cartridge as described in this specification. That is why currently existing hydraulic circuit toolholders used a separate fill port and vent port, typically positioned so that one port is at the bottom for filling and one port is at the top for venting. The seal 214 of the present invention is installed in such a way that it is self-vented. The fill procedure and structure of the present invention described above for filling the hydraulic circuit 211 virtually eliminates trapped air from the hydraulic circuit 211. The only other concern then is not to trap air under seal 214 when the seal is inserted at the end of the fill operation. The present invention avoids such trapped air by using an insertion tool 914, shown in FIGS. 13A and B, for insertion of the seal 214 into the piston cylinder 201. Insertion tube 915 of insertion tool 914 is inserted into oil/air escape through-hole 529 of seal 214 at piston engagement end 901. Seat 904 of seal 214 is then inserted into piston cylinder 201 by, for example, gripping shaft 916 of insertion tool 914 and pushing the seat 904 of the seal to a depth less than the depth where the maximum designed torque is exerted upon a cutting tool or workpiece in inner bore 109 of the largest diameter cutting tool that the holder is designed to accommodate. The maximum insertion distance of seal displacement 631 is when seal 214 is driven by the actuator screw 204 and piston 215 combination in piston cylinder 201 to the point where maximum designed torque will be exerted upon a cutting tool or workpiece in inner bore 109 for the smallest diameter cutting tool or workpiece that the holder is designed to accommodate. The minimum insertion distance of seal displacement 631 is when seal 214 is driven by the actuator 204 and piston 215 combination in piston cylinder 201 to the point where maximum designed torque will be exerted upon a cutting tool in inner bore 109 for the largest diameter cutting tool or workpiece that cartridge holder 203 is designed to accommodate. Upon reaching near to the minimum insertion distance, air and then hydraulic oil will be forced out through the bore 917 of insertion tool 914, thereby achieving the proper depth of seal 214 within piston cylinder 201 to assure cartridge's 107 designed range of seal displacement 631. Air and oil from bore 917 exits out through pipe 918, which is in communication with bore 917. The air and oil exits into the space in piston cylinder 201 bounded by insertion tool shaft 916 first diameter 919, second diameter 920, and seal 214 where it can be drained out or washed out when insertion tool 914 is removed. Insertion tool 914 first diameter 919 is close to the diameter of cartridge piston bore 108 to reduce lateral movement of insertion tube 915 in oil/air escape through-hole 529 in seal 214. The volume of the displaced air and hydraulic fluid does not expand cartridge inner wall 206 of the cartridge 107, since it is forced out of the hydraulic circuit 531. Insertion tool 914 is then retracted from seal 214 oil/air escape through-hole 529. Friction of seal 214 against the circumferential wall of piston cylinder 201 maintains the seal 214 at its established depth. Actuator 204 and piston 215 are then inserted into piston cylinder 201 so that seal engagement surface 905, seal compressor 907, and compression taper 910 engage piston engagement end 901 and engagement end taper 911 of seal 214. To engage a cutting tool or workpiece in the cartridge inner bore 109, actuator 204 is adjusted into piston bore 108 until the cartridge inner wall 206, due to compression of hydraulic fluid, exerts the desired holding torque on the cutting tool or workpiece.

Cartridge 107 with the collocated fill and bleed channels 409 illustrated in FIGS. 4A, B, and C is somewhat slower to fill than the cartridge 107 with the separate fill and bleed channels 316A and B of FIGS. 3A, B, and C. Otherwise, the same performance advantage over toolholders having an integral hydraulic circuit 211 is achieved. Hydraulic circuit 211 configuration of the present invention is also adaptable to be used as an integral hydraulic circuit in a hydraulically actuated toolholder. The more economical manufacturing advantage of a separate hydraulic cartridge would be lost, but the advantages of ease of filling the hydraulic circuit 211 with hydraulic fluid and the ability to virtually eliminate any air in the hydraulic fluid would be a significant advantage over the present day integral hydraulic circuit actuated toolholders. In one such embodiment of the present invention, hydraulic circuit 211 configuration is machined into the bore 106 of toolholder 202 and piston cylinder 201 is drilled into toolholder 202 along a diameter of the hydraulic toolholder 202 and at a point on the longitudinal axis of bore 106 so that piston cylinder 201 intersects and is in communication with fill/bleed channels 316A and B. Thin cartridge shell 210 is then inserted into bore 106 of toolholder 202 and affixed in place such as by brazing. In all other respects, this embodiment would be the same as cartridge 107 embodiment. Yet, another alternative is to machine hydraulic circuit 211 into the exterior wall of nosepiece 103 of toolholder 202, place shell 210 over nosepiece 103 in the region of hydraulic circuit 211, and braze shell 210 to nosepiece 103 to achieve a leak proof seal. First actuator access port 105 is bored through nosepiece 103 in alignment with piston cylinder 201 as shown in FIG. 1.

Furthermore, currently available toolholders with an integral hydraulic circuit can be retrofitted with the self venting seal 214 of the present invention. Retro-fit will generally include the installation of a piston cylinder 201, seal 214, piston 215, and actuator 204. One method of accomplishing the retrofit is to first drill piston cylinder 201 along a transverse axis of the nosepiece 103 so that piston cylinder 201 intersects with hydraulic circuit 211. Hydraulic circuit 211 is then filled with hydraulic fluid in the manner described in this specification. Seal 214 is inserted into piston cylinder 201 to the desired depth, whereby some of the hydraulic fluid escapes out of oil/air escape through hole 529 of seal 214. As done with previous embodiments in this specification, piston 215 is inserted into piston cylinder 201 so that piston pin 906 mates with oil/air escape through hole 529 in seal 214. Insertion of actuator 204 into piston cylinder 201 completes the retro-fit. The bleed hole in the retrofitted toolholder is capped off by the original manufacturer before sale, therefore nothing further must be done with the existing bleed-hole unless it is leaking in which case it must be repaired.

Previously in this Detailed Description of the Invention, a method of filling cartridge 107 was presented and compared to the generally used current method of vacuum filling. This can also be utilized for filling hydraulic cartridge 107 of the various embodiments of the invention described in this specification. For example, cartridge 107 may be placed in a chamber filled with hydraulic fluid to a level covering second actuator access port 322 and then drawing a partial vacuum in the chamber. The lower chamber pressure will cause air in hydraulic circuit 211 to escape while simultaneously filling hydraulic circuit 211.

FIG. 5 is a further view illustrating cartridge body 209 pressed into cartridge shell 210. Portions of annular hydraulic circuit 211 are shown. FIG. 5 illustrates placement of seal 214 and in-line piston 215 into piston cylinder 201. FIG. 6 illustrates the next assembly sequence with piston 215 into cylinder 201. Piston pin 906 is fully inserted into oil escape through-hole 529 of seal 214 and piston seal engagement surface 905 is engaged with engagement end 901 of seal 214. With piston pin 906 fully inserted into oil escape through-hole 529 of seal 214, no further hydraulic fluid may escape from hydraulic circuit 211 and the circuit is a closed loop. Actuator 204 is not shown in FIG. 6, but the threaded portion of 204 displaces piston 215 and seal 214 deeper into cylinder 201 up to the range of displacement distance 631. The required seal displacement range is proportional to the range of compression that must be accommodated within hydraulic circuit 211. Wall 206 is designed to be thin enough that it is able to flex in order to transmit a compresive force against a tool or workpiece in inner bore 109 in the region of clamping bands 319 and 320 to provide a clamping force proportional to the seal displacement range 631. Therefore, when actuator 204 travels a set amount in cylinder 201, for any given inner bore 109 and cutting tool diameter, the pressure on the cutting tool and thus the frictional gripping force rises. Although, actuator 204 and piston 215 are shown as two separate parts, they could be manufactured as a single integral unit. Furthermore, the design of piston 215 could be changed to eliminate compression taper 910, and/or seal compressor 907. Likewise, seal 214 could be any sealing means such as a straight cylinder having a diameter large enough to form a leakproof fit with piston cylinder 201. Additionally, the structure for filling hydraulic circuit 211, containing the hydraulic fluid in hydraulic circuit 211, and compressing the hydraulic fluid within hydraulic circuit 211 may be modified and located differently than shown in the FIGS. 2 through 6. This invention contemplates that the functional requirements are that there must be a leakproof structure that maintains hydraulic fluid in hydraulic circuit 211 and the hydraulic fluid must be capable of being compressed in hydraulic circuit 211. The function of compressing hydraulic fluid could be accomplished by a piston and piston cylinder combination leading directly into a clamping band 319 or 320.

Two smaller volume clamping bands 319 and 320 are preferred to one larger volume band because two bands provide more coaxial locational forces along the shank of the cutting tool. However, in certain applications, a single clamping band would be sufficient and such is contemplated by this invention.

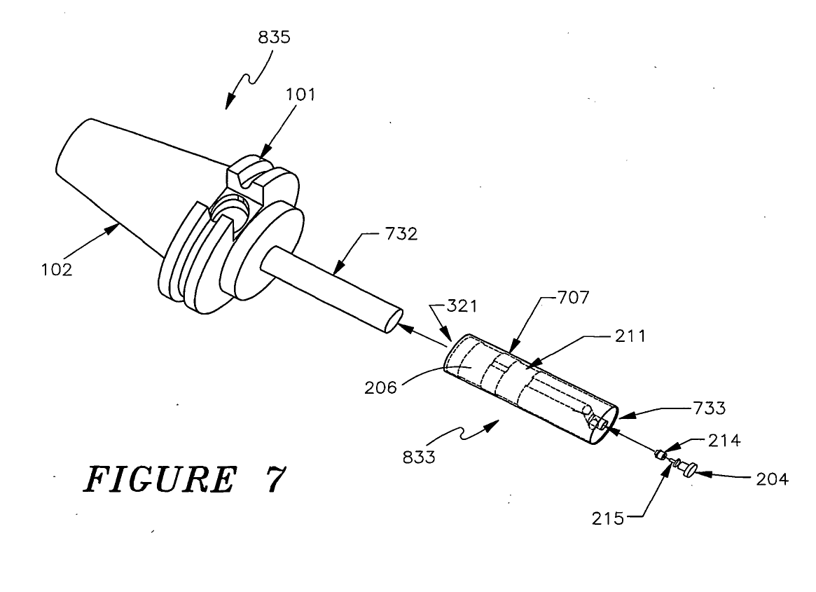

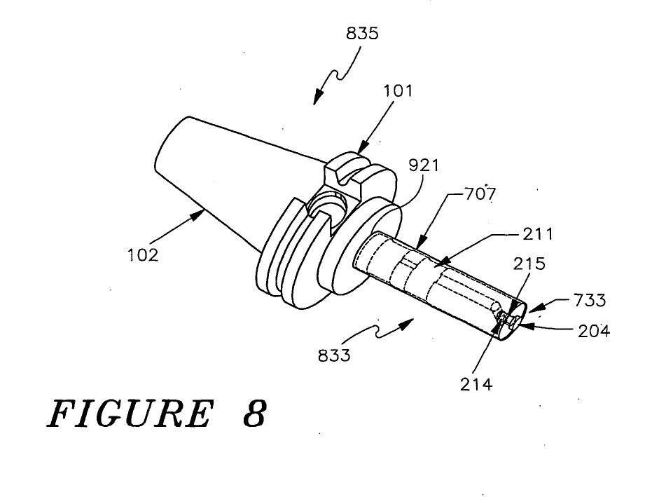

FIGS. 7 and 8 illustrate a further adaptation of the concept of this invention, which is hydraulic circuit 211 contained in mandrel cartridge 833 combined with at least shank 102 portion of prior art toolholder 202, to form mandrel holder 835. In both FIGS. 7 and 8, mandrel cartridge 833 is the male fitting that engages the female fitting workpiece or tool. In the previous adaptation of the concepts presented in this specification, cartridge 107 contained the female fitting (inner bore 109) into which a cutting tool or workpiece was inserted. In this embodiment, mandrel cartridge 833 is used as an expanding mandrel. Although, FIGS. 7 and 8 illustrate a cylindrical mandrel cartridge 833 as the mandrel, the mandrel may be of any shape such as a tapered, hexagonal, or rectangular shape for mating engagement with a compatible workpiece or tool during machining. FIG. 7 shows a mandrel holder 835 comprising at least shank 102 portion of prior art toolholder 202, cylindrical end 732, and mandrel cartridge 833. Cylindrical end 732 may be of a noncylindrical shape so long as it matingly fits with end bore 321. End bore 321 of mandrel cartridge 833 fits over cylindrical end 732. In this application, insertion end 733 is inserted into the workpiece or tool, to a depth equal to or less than the length of mandrel cartridge 833. Actuation of actuator 204 of mandrel cartridge 833 will expand deformable outer cartridge shell 707 against inner wall of the workpiece or tool bore to clamp the workpiece or tool onto mandrel cartridge 833. End bore 321 may also be deformable in the same manner and with substantially the same structure as cartridge 107 by hydraulic circuit 211 within mandrel cartridge 833 to clamp mandrel cartridge 833 to cylindrical end 732 or the clamping may be accomplished by using an arbor to press fit end bore 321 of mandrel cartridge 833 over cylindrical end 732 in an interference fit. FIG. 8 illustrates another embodiment of mandrel holder 835. In this embodiment, mandrel cartridge 833 is an integral part of mandrel holder 833; thereby eliminating cylindrical end 732 shown in FIG. 7. Filling hydraulic circuit 211 and installing seal 214, piston 215, and actuator for each of the embodiments shown in FIGS. 7 and 8 can be accomplished in the same manner as that previously described in this specification. The location of piston cylinder 201, however, is more accessible if bored into mandrel cartridge 833 on its longitudinal axis at the insertion end 733 of mandrel cartridge 833 as shown in FIGS. 7 and 8. Various modifications and variations of this invention will become apparent to those skilled in the art without departing from the scope and spirit of this invention, and it should be understood that this invention is not to be unduly limited to the illustrative embodiments set forth in this specification.

1. A hydraulic holder comprising:
(a) a shank for mating engagement with a rotating machining device;
(b) a nosepiece in axial alignment with the shank having an axial bore; and
(c) a hydraulic cartridge fixedly mounted in the bore, whereby the hydraulic cartridge may be actuated to clamp a tool or a workpiece in the inner bore of the cartridge.

2. A hydraulic cartridge comprising:
(a) a cartridge shell;
(b) surrounding a cartridge body,
(c) the cartridge body having a hydraulic circuit filled with hydraulic fluid, a means of compressing the hydraulic fluid within the hydraulic circuit, and a deformable inner wall surrounding an inner bore so that upon compression of the hydraulic fluid within the hydraulic circuit the inner wall deforms into the inner bore for mating engagement with a tool or workpiece within the inner bore.

3. A hydraulic holder comprising:
(a) a shank for mating engagement with a rotating machining device;
(b) a nosepiece in axial alignment with the shank having an axial bore and a first actuator access port;
(c) a cartridge inserted into the axial bore of the nosepiece;
(d) the cartridge having a body and a shell surrounding the body;
(e) the shell having a second actuator access port in radial alignment with the first actuator access port;
(f) the body having a hydraulic circuit filled with hydraulic fluid, the hydraulic circuit having a piston in a piston cylinder which piston cylinder is in radial alignment with the first and second actuator access ports whereby longitudinal movement of the piston into the piston cylinder compresses the hydraulic fluid against a deformable inner wall surrounding an inner bore which inner bore is configured for mating engagement with an inserted tool or workpiece, and the tool or workpiece is clamped in the inner bore by compression of the deformable wall by the hydraulic fluid.

4. The cartridge of claim 2, wherein the means for compression of the hydraulic fluid within the cartridge is:
(a) an actuator access port in the cartridge shell and
(b) a piston in a piston cylinder which piston cylinder is in radial alignment with the actuator access port in the cartridge shell whereby longitudinal movement of the piston into the piston cylinder compresses the hydraulic fluid within the cartridge.

5. The hydraulic holder of claim 1, further comprising:
(a) a first actuator access port in the nosepiece of the holder;
(b) a second actuator access port in a cartridge shell in radial alignment with the first actuator access port;
(c) a cartridge body fluid tightly affixed in the cartridge shell;
(d) the cartridge body having (i) a piston cylinder in radial alignment with the first actuator access port and the second actuator access port, ii) a first annular positioning ring with the piston cylinder extending radially through the first annular positioning ring and at least one channel disposed longitudinally in the first annular positioning ring and in communication with the piston cylinder and with an upper clamping band, (iii) a first end of the upper clamping band adjacent the first annular positioning ring and surrounding a portion of a deformable inner wall, (iv) a second annular positioning ring adjacent a second end of the upper clamping band and surrounding a portion of the inner wall, the second annular positioning ring having at least one longitudinally disposed clamping channel, (v) a lower clamping band with a first end of the lower clamping band adjacent the second annular positioning ring and the lower clamping band surrounding a portion of the inner wall that is deformable, (vi) a third annular positioning ring adjacent a second end of the lower clamping band and surrounding a portion of the inner wall, (vii) the inner wall surrounding and forming an inner bore, (viii) an actuator adjustable radially through the first annular positioning ring, a piston moveable by the actuator, and a seal moveable by the piston through a seal displacement range, the actuator, piston, and seal in radial alignment with one another in the piston cylinder so that the seal is proximate to the at least one channel, and (ix) hydraulic fluid filling the portion of the piston cylinder proximate the seal, at least one channel, the upper clamping band, the at least one clamping channel, and the lower clamping band.

6. An apparatus for clamping a tool or workpiece in a rotating machining device, comprising:
(a) a shank for mating engagement with a rotating machining device having an axial bore therein;
(b) a hydraulic cartridge fixedly engaged in the bore of the shank, for clamping a tool or workpiece in the inner bore of the cartridge.

7. An apparatus for clamping a tool or workpiece in a rotating machining device, comprising:
(a) a shank for mating engagement with a rotating machining device;
(b) a nosepiece affixed in axial alignment to the shank having an axial bore therein; and
(c) a hydraulic cartridge fixedly engaged in the bore of the nosepiece, for clamping a tool or workpiece in the inner bore of the cartridge.

8. The apparatus of claim 7, further comprising:
(a) a first actuator access port in the nosepiece;
(b) a second actuator access port in a cartridge shell in radial alignment with the first access port in the nosepiece;
(c) a cartridge body affixed fluid tight in the cartridge shell; and
(e) the cartridge body having (i) a piston cylinder in axial alignment with the first and second actuator access ports, (ii) a first annular positioning ring having the piston cylinder extending radially through the first annular positioning ring and at least one channel disposed longitudinally in the first annular positioning ring and in communication with the piston cylinder, (iii) an upper clamping band with a first end of the upper clamping band adjacent the first annular positioning ring and surrounding a portion of a deformable inner wall, (iv) a second annular positioning ring adjacent a second end of the upper clamping band, surrounding a portion of the inner wall, and having at least one longitudinally disposed clamping channel, (v) a lower clamping band with a first end of the lower clamping band adjacent the second annular positioning ring and surrounding a portion of the inner wall that is deformable, (vi) a third annular positioning ring adjacent a second end of the lower clamping band and surrounding a portion of the inner wall, (vii) the inner wall surrounding and forming a tool inner bore, (viii) an actuator adjustable radially through the first annular positioning ring, a piston moveable by the actuator, and a seal moveable by the piston through a seal displacement range, the actuator, piston, and seal in axial alignment with one another in the piston cylinder so that the seal is proximate to the at least one channel, and (ix) hydraulic fluid filling the portion of the piston cylinder proximate the seal, the at least one channel, the upper clamping band, the at least one clamping channel, and the lower clamping band.

9. The hydraulic toolholder of claim 1, wherein the hydraulic circuit comprises:
(a) a piston cylinder;
(b) a first annular positioning ring with the piston cylinder extending radially through the first annular positioning ring and at least one channel disposed longitudinally in the first annular positioning ring in communication with the piston cylinder;
(c) a clamping band with a first end of the clamping band adjacent the first annular positioning ring the clamping band surrounding a portion of a deformable inner wall, and the first end of the clamping band in communication with the at least one channel;
(d) a second annular positioning ring adjacent a second end of the clamping band, the annular positioning ring surrounding a portion of the inner wall, and
(e) the inner wall surrounding and forming a tool inner bore.

10. A hydraulic holder comprising:
(a) a toolholder having a hydraulic circuit in a toolholder bore wall;
(b) a deformable inner cartridge shell affixed fluid tight around the toolholder bore wall; and
(c) hydraulic fluid in the hydraulic circuit and a means for compressing the hydraulic fluid in the hydraulic circuit to deform the inner cartridge shell inwardly to matingly engage a tool or workpiece located within the inner bore of the inner cartridge shell.

11. A hydraulic toolholder comprising:
(a) a toolholder having a hydraulic circuit in a nosepiece outside wall;
(b) a deformable outer cartridge shell affixed fluid tight around the nosepiece outside wall; and
(c) hydraulic fluid in the hydraulic circuit and a means for compressing the hydraulic fluid in the hydraulic circuit to deform the outer cartridge outwardly to matingly engage the bore of a tool or workpiece located around the outer cartridge shell.

12. A mandrel cartridge comprising:
(a) a deformable outer cartridge shell;
(b) surrounding a mandrel cartridge body;
(c) the mandrel cartridge body having a hydraulic circuit filled with hydraulic fluid, a means of displacing the hydraulic fluid within the hydraulic circuit, so that upon compression of the hydraulic fluid within the hydraulic circuit the deformable outer cartridge shell deforms outwardly for mating engagement with a bore in a tool or workpiece.

13. The mandrel cartridge of claim 12, also comprising a shank affixed to a first end of the mandrel cartridge in axial alignment with the first end of the mandrel cartridge shell.

14. A hydraulic mandrel holder comprising:
(a) a shank portion;
(b) a cylindrical end affixed to the shank portion in axial alignment with the shank portion;
(c) a mandrel cartridge having a deformable outer cartridge shell, a cartridge body, at least one deformable inner wall portion, and a cylindrical end bore, defined by the deformable inner wall in the cartridge body, in mating engagement with the cylindrical ad;
(d) the cartridge body having a hydraulic circuit filled with hydraulic fluid and a means of compressing the hydraulic fluid with the hydraulic circuit, so that upon compression of the hydraulic fluid within the hydraulic circuit (i) the inner wall deforms inwardly for releasable fixed mating engagement with the cylindrical end and (ii) the deformable outer cartridge shell deforms outwardly for releasable fixed mating engagement with a bore in a tool or workpiece.

15. The process of removing air or excess hydraulic fluid from the hydraulic circuit of the hydraulic cartridge of claims 1 through 14, comprising the steps of:
(a) filling the hydraulic cartridge with hydraulic fluid through the piston cylinder;
(b) inserting a seal into the piston cylinder to the desired depth in the piston cylinder so that any air or excess hydraulic fluid will escape through an oil/air escape through-hole in the seal; and
(c) inserting a piston into the piston bore in axial alignment with the seal, so that a piston pin is matingly inserted into the oil/air escape through-hole in the seal.

16. The process of removing air or excess hydraulic fluid from the hydraulic circuit of the hydraulic ridge of claim 15, further comprising the steps of:
(a) first inserting an insertion tube of an insertion tool into the oil/air escape through-hole in the seal and then, using the insertion tube, moving the seal in the piston cylinder to the desired depth in the piston cylinder, whereby any air or excess hydraulic fluid will escape into the bore of the insertion tube and out the through pipe of the insertion tool; and
(b) removing the insertion tool with its insertion tube from the piston cylinder and oil/air escape through-hole.

17. The process of filling the hydraulic circuit of the hydraulic cartridge of claims 1 through 14, comprising the steps of:
(a) placing the hydraulic cartridge in a air evacuation chamber;
(b) raising the piston cylinder end of the hydraulic cartridge above the opposite end of the hydraulic cartridge with the piston cylinder directed upwardly,
(c) lowering the pressure in the chamber to less than ambient pressure;
(d) filling the hydraulic cartridge through the piston cylinder;
(e) after the piston cylinder is full of hydraulic fluid and air ceases to exit through the piston cylinder, inserting a seal into the piston cylinder to the desired depth in the piston cylinder, whereby hydraulic fluid in the piston cylinder that is displaced by insertion of the seal escapes out of the oil/air escape tube; and
(f) removing the insertion tool and inserting a piston pin of a piston into the seal.

18. A method of retro-fitting a hydraulic toolholder having an intregral hydraulic circuit with a piston cylinder, seal, piston, and actuator, comprising the steps of:
(a) drilling a piston cylinder along a transverse axis of the nosepiece so that the piston cylinder intersects with the hydraulic circuit;
(b) filling the hydraulic circuit with hydraulic fluid;
(c) inserting a seal into the piston cylinder to the desired depth, whereby some of the hydraulic fluid escapes out of the seal oil/air escape through hole;
(d) inserting a piston into the piston cylinder so that the piston pin mates with the oil/air escape through hole in the seal; and,
(e) inserting an actuator into the piston cylinder.

19. A hydraulic cartridge comprising:
(a) deformable cartridge shell, having an actuator access port, the cartridge shell surrounding a cartridge body;
(b) the cartridge body having:
(i) a piston cylinder in alignment with the actuator access port;
(ii) the piston cylinder extending into a first annular positioning ring;
(iii) at least one fill/bleed channel disposed longitudinally in the first annular positioning ring and the at least one fill/bleed channel in communication with the piston cylinder and with a clamping band;
(iv) the first annular positioning ring adjacent a first end of the clamping band;
(v) a second end of the clamping band adjacent a second annular positioning ring;
(vi) the clamping band surrounding at least a portion of that portion of the inner wall of the cartridge body that is deformable and surrounding a portion of the cartridge shell;
(vii) the inner wall surrounding and forming an inner bore in axial alignment with the cartridge body;
(viii) an actuator adjustable into the piston cylinder, a piston moveable by the actuator, and a seal moveable by the piston through a seal displacement range, the actuator, piston, and seal in axial alignment with one another in the piston cylinder with the seal proximate to the at least one fill/bleed channel; and,
(ix) a hydraulic circuit filled with hydraulic fluid, the hydraulic circuit comprised of the space bounded by that portion of the piston cylinder proximate a seat of the seal, the at least one fill/bleed channel, the first annual positioning ring, the cartridge shell, the inner wall, and the second annual positioning ring, so that upon compression of the hydraulic fluid, by actuation of the actuator, piston, and seal combination, within the piston cylinder so that at least that portion of the inner wall that is deformable deforms and the cartridge shell deforms for mating engagement with a tool or workpiece.

20. The hydraulic cartridge of claim 19, wherein the cartridge shell is rigid, so that upon compression of the hydraulic fluid at least that portion of the inner wall that is deformable deforms for mating engagement with a tool or workpiece in the inner bore.

21. The hydraulic cartridge of claim 19, wherein the hydraulic circuit is formed in a solid cartridge body, the hydraulic circuit comprised of the space bounded by that portion of the piston cylinder proximate the seat of the seal, the at least one fill/bleed channel, the first annual positioning ring, the cartridge shell, the cartridge body, and the second annual positioning ring, so that upon compression of the hydraulic fluid, by actuation of the actuator, piston, and seal combination, within the piston cylinder at least a portion of the deformable cartridge shell deforms for mating engagement with a tool or workpiece.

22. The hydraulic cartridge of claim 19, wherein the cartridge body is also comprised of
(a) a second clamping band surrounding at least a portion of the deformable inner wall and a portion of the deformable cartridge shell,
(b) a first end of the second clamping band adjacent the second annular positioning ring, the second annular positioning ring having at least one longitudinally disposed clamping channel,
(c) a third annular positioning ring adjacent a second end of the second clamping band and surrounding at least a portion of the inner wall and a portion of the cartridge shell, and
(d) a hydraulic circuit filled with hydraulic fluid, the hydraulic circuit comprised of the space bounded by that portion of the piston cylinder proximate a seat of the seal, the at least one fill/bleed channel, the first annual positioning ring, the second annual positioning ring, the at least one longitudinally disposed clamping channel in the second annual positioning ring, the cartridge shell, and the inner wall, so that upon compression of the hydraulic fluid, by actuation of the actuator, piston, and seal combination, within the piston cylinder at least a portion of the deformable inner wall and the deformable cartridge shell deforms for mating engagement with a tool or workpiece.

23. The hydraulic cartridge of claims 20 and 21, wherein the cartridge body is also comprised of:
(a) a second clamping band surrounding at least a portion of the deformable inner wall or a portion of the deformable cartridge shell;
(b) a first end of the second clamping band adjacent the second annular positioning ring, the second annular positioning ring having at least one longitudinally disposed clamping channel;
(c) a third annular positioning ring adjacent a second end of the second clamping band;
(d) the second clamping band surrounding at least a portion of the inner wall and a portion of the cartridge shell; and,
(e) a hydraulic circuit filled with hydraulic fluid, the hydraulic circuit comprised of the space bounded by that portion of the piston cylinder proximate a seat of the seal, the at least one fill/bleed channel in the first annual positioning ring, the first annual positioning ring, the second annual positioning ring, the at least one longitudinally disposed clamping channel in the second annual positioning ring, the cartridge shell, and the inner wall, so that upon compression of the hydraulic fluid, by actuation of the actuator, piston, and seal combination, within the piston cylinder at least a portion of the deformable inner wall or the deformable cartridge shell deforms for mating engagement with a tool or workpiece.

24. The hydraulic cartridge of claim 19, wherein the seal further comprises a seat, taper, flange, piston engagement end, engagement end taper, and oil/air escape through-hole.

25. The hydraulic cartridge of claim 19, wherein the piston further comprises a seal engagement surface, compression taper, and seal compressor.

26. The hydraulic cartridge of claim 19, wherein the actuator further comprises a head cap, shoulder for engagement with a neck in the holder body, threaded portion, and contact end.

27. The hydraulic cartridge of claim 19, wherein there is a rounded surface at the junction between the bleed/fill channel and the piston cylinder for ease of insertion of a tube into the fill channel for filling the hydraulic circuit with hydraulic fluid.

28. The process of filling the hydraulic circuit of the hydraulic cartridge of claims 1 through 14 and 19 through 27, comprising the steps of:
(a) filling the hydraulic circuit with hydraulic fluid through the piston cylinder;
(b) after the hydraulic circuit is full of hydraulic fluid and air ceases to exit through the piston cylinder, inserting the seal into the piston cylinder to a minimum insertion depth in the piston cylinder so that hydraulic fluid in the piston cylinder is displaced by the seal and escapes out of the oil/air escape through-hole;
(c) inserting the piston into the piston cylinder for mating engagement of the piston pin with the oil/air escape through-hole; and,
(d) inserting the actuator into the piston cylinder for engagement of the actuator contact end with the piston cap to close off the piston cylinder so that the hydraulic circuit is a closed loop.

29. The process of filling the hydraulic circuit of the hydraulic cartridge of claim 28, comprising the additional steps of:
(a) inserting a hydraulic fluid feed-tube through the piston cylinder and into the fill/bleed channel;
(b) filling the hydraulic circuit with hydraulic fluid through the feed-tube; and,
(c) after the hydraulic circuit is full of hydraulic fluid and air ceases to exit through the piston cylinder, removing the tube from the piston cylinder.

30. The process of filling the hydraulic circuit of the hydraulic cartridge of claim 29, comprising the additional steps of:
(a) tilting the hydraulic cartridge at an angle from vertical during the filling process to facilitate removal of air from the hydraulic circuit and to reduce fill time; and,
(b) maintaining the fill/bleed channel in the up position during the filling process.

31. The process of claim 16, wherein the insertion tool also comprises an axial bore in the insertion tube, a through pipe in communication with the bore, and a shaft attached to the insertion tube.

32. The insertion tube of claim 31, wherein the shaft has a first diameter substantially equivalent to the diameter of the piston cylinder and a through pipe transversely located in a second diameter which is less than the first diameter.

33. A cartridge comprising:
(a) a cartridge shell;
(b) surrounding a cartridge body, and,
(c) the cartridge body having a fluid circuit filled with fluid, a means of compressing the fluid within the fluid circuit, and at least one deformable wall so that upon compression of the fluid within the fluid circuit the wall deforms for mating engagement with a tool or workpiece within the inner bore.

34. The process of filling the hydraulic circuit of the hydraulic cartridge of claim 28, comprising the additional steps of:
(a) inserting a hydraulic fluid feed-tube through the piston cylinder and into a first of two fill/bleed channels;
(b) filling the hydraulic circuit with hydraulic fluid through the feed-tube; and,
(c) after the hydraulic circuit is full of hydraulic fluid and air ceases to exit through the second of the two fill/bleed channels and into the piston cylinder, removing the feed-tube from the first fill/bleed channel and the piston cylinder.

35. The process of filling the hydraulic circuit of claim 17 also comprising the step of filling the air evacuation chamber with hydraulic fluid to a level covering the piston cylinder.

36. A hydraulic toolholder comprising:
(a) a hydraulic circuit in the outside wall of the toolholder nosepiece;
(b) a deformable outer cartridge shell affixed fluid tight around the hydraulic circuit in the nosepiece outside wall;
(c) hydraulic fluid in the hydraulic circuit;
(d) the hydraulic circuit having a piston in a piston cylinder which piston cylinder is a longitudinal piston bore extending from the insertion end of the nosepiece to the hydraulic circuit;
(e) an actuator in the piston cylinder, adjustable from the insertion end towards the hydraulic circuit, a piston moveable by the actuator, and a seal moveable by the piston through the seal displacement range, the actuator, piston, and seal in alignment with one another in the piston cylinder so that the seal is proximate to the hydraulic circuit; and,
(f) whereby longitudinal movement of the piston into the piston cylinder compresses the hydraulic fluid in the hydraulic circuit to outwardly deform the cartridge shell for releasable mating engagement with a bore in a tool or workpiece located around the cartridge shell.

37. A mandrel cartridge comprising:
(a) a deformable cartridge shell;
(b) surrounding a mandrel cartridge body;
(c) the mandrel cartridge body having a hydraulic circuit filled with hydraulic fluid;
(d) the hydraulic circuit having a piston in a longitudinal piston cylinder extending from the insertion end of the cartridge body to the hydraulic circuit;
(e) an actuator in the piston cylinder, adjustable from the insertion end towards the hydraulic circuit, a piston moveable by the actuator, and a seal moveable by the piston through the seal displacement range, the actuator, piston, and seal in alignment with one another in the piston cylinder so that the seal is proximate to the hydraulic circuit;
(f) whereby longitudinal movement of the piston into the piston cylinder compresses the hydraulic fluid against the deformable cartridge shell to deform the cartridge shell outwardly for releasable mating engagement with a bore in a tool or workpiece.

38. The mandrel cartridge of claim 37, also comprising a shank affixed to a first end of the mandrel cartridge in axial alignment with the first end of the mandrel cartridge shell.

39. A hydraulic mandrel holder comprising:
(a) a shank portion;
(b) a cylindrical end affixed to the shank portion in axial alignment with the shank portion;
(c) a mandrel cartridge having a deformable outer cartridge shell surrounding a cartridge body, a cylindrical end bore surrounded by an inner wall of the cartridge body, the inner wall having at least one deformable portion and configured for mating engagement with the cylindrical end;
(d) the cartridge body having a hydraulic circuit filled with hydraulic fluid;
(e) a piston cylinder extending from the insertion end of the cartridge body to the hydraulic circuit;
(f) an actuator in the piston cylinder, adjustable from the insertion end towards the hydraulic circuit, a piston moveable by the actuator, and a seal moveable by the piston through the seal displacement range, the actuator, piston, and seal in alignment with on another in the piston cylinder so that the seal is proximate to the hydraulic circuit; and,
(g) so that upon compression of the hydraulic fluid within the hydraulic circuit the inner wall deforms inwardly for releasable fixed mating engagement with the cylindrical end and the deformable outer cartridge shell deforms outwardly for releasable fixed mating engagement with a bore in a tool or workpiece.

40. The hydraulic cartridge of claim 1, wherein the hydraulic cartridge also comprises a hydraulic circuit comprised of:
(a) a piston cylinder;
(b) a first annular positioning ring with the piston cylinder extending radially through the first annular positioning ring and at least one channel disposed longitudinally in the first annular positioning ring in communication with the piston cylinder;
(c) a clamping band with a first end of the clamping band adjacent the first annular positioning ring, the clamping band surrounding a portion of a deformable inner wall, and the first end of the clamping band in communication with the at least one channel;
(d) a second annular positioning ring adjacent a second end of the clamping band, the annular positioning ring surrounding a portion of the inner wall; and
(e) the inner wall surrounding and forming a tool inner bore.
